(19) United States
(12) Patent Application Publication
(10) Pub. No.: US 2024/0165554 A1
(43) Pub. Date: May 23, 2024

(54) TWO-STAGE ELECTROCHEMICAL OXYGEN CONCENTRATOR, PURIFIER, AND PRESSURIZER

(71) Applicant: American Oxygen, LLC, West Valley City, UT (US)

(72) Inventors: Dale M. Taylor, Salt Lake City, UT (US); Thomas D. Taylor, Bountiful, UT (US)

(73) Assignee: American Oxygen, LLC, West Valley City, UT (US)

(21) Appl. No.: 18/513,396

(22) Filed: Nov. 17, 2023

Related U.S. Application Data
(60) Provisional application No. 63/384,366, filed on Nov. 18, 2022.

(51) Int. Cl. B01D 53/32

(52) U.S. Cl. CPC B01D 53/326; B01D 2256/12; B01D 2257/102

(57) ABSTRACT

Two-stage systems for oxygen concentration and pressurization. A system includes a first stage oxygen concentrator that receives an input gas and outputs a first oxygen output gas. The system includes a second stage oxygen concentrator comprising a second electrochemical stack, wherein the second stage oxygen concentrator receives the first oxygen output gas and outputs a second oxygen output gas. The first oxygen output gas is stored at a first storage pressure up to a first maximum pressure, the second oxygen output gas is stored at a second storage pressure up to a second maximum pressure, and the second maximum pressure is greater than the first maximum pressure.

### TECHNICAL FIELD

The disclosure relates generally to the concentration, purification, and pressurization of oxygen gas and more particularly relates to ceramic devices for concentrating oxygen gas.

### BACKGROUND

Many industries and applications benefit from oxygen gas or high purity oxygen gas. Common uses of oxygen gas are in the medical field, in commercial applications, in industrial manufacturing and construction applications, in chemical manufacturing applications, and so forth. High purity oxygen serves a key role in many different industries. However, traditional methods for purifying oxygen are time, resource, and energy intensive. It is therefore desirable to develop systems, methods, and devices for purifying oxygen by way of low cost and low energy means.

Oxygen is the only element that supports respiration, and it is required to support life and maintain healthy biological processes. Because oxygen is imperative to life and health, separated oxygen and/or high purity oxygen is commonly used in medical applications. For example, medical oxygen is used as a basis for virtually all procedures that involve the use of anesthesia, medical oxygen is typically provided to all patients that are experiencing any respiratory distress, and all patients experiencing low blood oxygen levels. Providing high purity oxygen to a patient can restore the patient's tissue oxygen tension by improving oxygen availability in a wide range of conditions, including cyanosis, shock, sever hemorrhage, carbon monoxide poisoning, major trauma, cardiac arrest, and respiratory arrest. Oxygen can aid in resuscitation of a patient and provides a vital role in sustaining the patient's brain function and tissue health during a time of distress. Hospitals and clinics around the world need a constant ready-to-use supply of purified oxygen gas that can be provided to a patient at any time. Many hospitals, particularly smaller hospitals or remote hospitals rely on using individual tanks of oxygen gas. This can be extremely expensive and can be a significant financial burden on some medical facilities. In addition, as oxygen in the tanks are consumed, they must be refilled or replaced with pre-filled tanks, and this creates a risk a given medical facility will run out of their stored oxygen supply. This risk is particularly acute during inclement weather or after a local disaster such as a hurricane, earthquake, flooding, mudslide, forest fire, or other disaster when medical oxygen supplies are most needed. Therefore, it is desirable to provide systems, methods, and devices for generating purified oxygen on-site or near the consumer at a lower cost that is sustainable and requires less energy to produce and maintain and is less susceptible to environmental conditions.

Other important industries that rely on the use of high purity oxygen include a wide range of industrial manufacturing industries such as chemical manufacturing, raw material refinement, and others. Many manufacturing processes benefit from oxygen enrichment. For example, processes involving combustion are greatly improved by lowering the amount of nitrogen gas and increasing the amount of oxygen gas. The combustion efficiencies will increase due to a drop in heat loss as a result of lower mass flow rates. Further for example, processes involving gasification by which coal, or another carbon-based fuel is transformed into a synthesis gas, benefit from oxygen enrichment. Therefore, it is desirable to provide low-cost and high efficiency means for generating copious quantities of oxygen gas for use across many different industries.

One traditional method of generating oxygen gas is by way of cryogenic air separation. Historically, this method accounts for over 95% of all oxygen production and is performed at a central production plant and then distributed to end users. Cryogenic air separation is used to produce concentrated oxygen or nitrogen in high volumes. Air is commonly made up of oxygen, nitrogen, argon, carbon dioxide, water vapor, and other particles. Cryogenic air separation is based on each of these components having a different boiling point, i.e., when the component transitions from a liquid state to a gaseous state. In cryogenic air separation, the temperature of air is lowered so that nitrogen and oxygen separate based on their different boiling points. This occurs at around −300° F. If high purity oxygen is desired, then further distillation is required. Because the air must be lowered to an extremely cold temperature, cryogenic air separation is expensive in terms of money and energy resources. Further, because cryogenic air separation occurs at large production plants and must then be transported by way of cryogenic vessels or pressurized vessels, this method consumes enormous sums of energy and can be expensive for end users.

Another method of generating oxygen gas is by way of pressure swing adsorption. Pressure swing adsorption consumes air into a pressurized tank having zeolites. The zeolites, under pressure, create a dipole that allows for the collection of nitrogen and allows oxygen to pass. Pressure swing adsorption is not well suited for processes that require high purity oxygen gas, such as gas that is 95% or more oxygen. In some implementations, multi-stage pressure swing adsorption is capable of generating high purity oxygen, but the cost is tremendously high, and it is not a desirable process to perform. Pressure swing adsorption can be implemented on-site by an end user, but it cannot produce high purity or ultra-high purity oxygen without an enormous increase in cost. This method is typically used for low purity applications with an oxygen concentration of 93% or less.

In view of the foregoing. disclosed herein are systems, methods, and devices for improved oxygen concentration and pressurization.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic illustration of a system for two-stage oxygen concentration and pressurization;

FIG. 2 is a perspective view of an example first stage electrochemical stack configured to receive an input gas comprising oxygen and output purified oxygen gas;

FIG. 3 is a perspective view of an example second stage electrochemical stack configured to receive an input gas comprising lower pressure oxygen and output purified higher pressure oxygen gas;

FIG. 4A is a schematic cross-sectional view of layers within a single wafer of an electrochemical stack;

FIG. 4B is a schematic cross-sectional view of layers and components of two wafers of an electrochemical stack;

FIG. 4C is a schematic cross-sectional view of layers, components, and reactions occurring within and surrounding a wafer of an electrochemical stack;

FIG. 5A is a schematic cross-sectional view of layers within a single wafer of an electrochemical stack;

FIG. 5B is a schematic cross-sectional view of layers and components of two wafers of an electrochemical stack;

FIG. 5C is a schematic cross-sectional view of layers, components, and reactions occurring within and surrounding a wafer of an electrochemical stack.

FIG. 6A is a schematic cross-sectional view of a system for concentrating and pressurizing oxygen gas;

FIG. 6B is a schematic cross-sectional view of a system for concentrating and pressurizing oxygen gas, and further depicts the release of high-purity oxygen gas from an electrochemical stack disposed within a housing; and

FIG. 6C is a schematic cross-sectional view of a system for concentrating and pressurizing oxygen gas, and further depicts the buildup of pressure within a housing as an electrochemical stack releases high-purity oxygen gas.

### DETAILED DESCRIPTION

The present disclosure extends to systems, methods, and devices for oxygen concentration and pressurization. Specifically disclosed herein are systems, methods, and devices for two-stage oxygen concentration and pressurization. The systems described herein leverage ceramic-based electrochemical oxygen concentrators that separate oxygen containing molecules on an atomic level to output ultra-high purity oxygen gas.

There are numerous industries and procedures that benefit from purified oxygen gas. In some instances, it may be beneficial or even necessary to use high purity oxygen gas that has a 95% or greater concentration of oxygen molecules. However, the methods known in the art for generating oxygen gas at any concentration, and particularly at high concentration levels, can be very costly in terms of time, money, and energy resources. Further, such methods are typically implemented at large production plants and then shipped to end users in pressurized vessels or specialized cryogenic transport and containment systems. This causes a supply chain risk that can lead to devastating consequences in certain instances such as a natural disaster where oxygen is necessary for medical needs but cannot be shipped due to infrastructure problems. Disclosed herein are systems, methods, and devices for generating high purity or ultra-high purity oxygen gas. The systems, methods, and devices disclosed herein are cost efficient and energy efficient, can be deployed on-demand, eliminate the need for oxygen gas cylinders or cryogenic containers, eliminate supply chain risks, and can produce ultra-high purity oxygen that far exceeds regulatory purity specifications.

An embodiment of the disclosure deploys an electrochemical stack including multiple wafers. Each of the multiple wafers includes multiple layers, including an anode, a cathode, and a ceramic electrolyte. The wafers of the electrochemical stack are configured to accept gaseous molecules when air or some other oxygen containing gas is passed through the electrochemical stack. The electrolyte layer within each of the multiple wafers is configured to accept or draw in oxygen ions while remaining non-permeable to other non-oxygen ions, atoms, or molecules. When an input gas is exposed to a wafer of the electrochemical stack, oxygen molecules are separated from other components in the input gas, such as argon gas, nitrogen gas, carbon dioxide, and others. The separated oxygen is harnessed and may be stored in a tank or immediately used. The other non-oxygen components may also be harnessed or may be released into the environment. The electrochemical stack disclosed herein may generate high purity or ultra-high purity oxygen using only a fraction of the energy that is required to deploy traditional oxygen purification methods such as cryogenic air separation and/or pressure swing adsorption and/or vacuum swing adsorption and/or water electrolysis.

In an embodiment, an electrochemical cell stack is configured to generate extremely high purity oxygen streams in excess of 99.9% purity at very high volumes. The volumetric flow of the electrochemical cell multi-stack system may be equivalent to or superior to the volumetric flow of cryogenic separation systems in some embodiments. The electrochemical cell stack may be run at elevated temperature with a voltage applied. The electrochemical cell stack is constructed of a plurality of wafers that include metals and ceramic oxides. When air (or any oxygen-containing gas) is passed over the electrochemical cell stack, a voltage is applied that electrolyzes and splits oxygen molecules in stable oxygen gas (O₂) and generates two separate negatively charged oxygen ions (2O²⁻) per oxygen molecule (the negatively charged oxygen ions may be referred to herein as oxygen anions). Oxygen ions can also be extracted from other oxygen containing gases such as water and carbon dioxide. The oxygen ions migrate through the ceramic electrolyte membrane of the wafers in the electrochemical cell stack due to an applied EMF (electromotive force). Because the specialized selection of materials in the ceramic membrane do not transport non-oxygen ions, the process only filters oxygen at an exceptionally high purity rate.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the structure, systems, and methods for producing an image in a light deficient environment are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

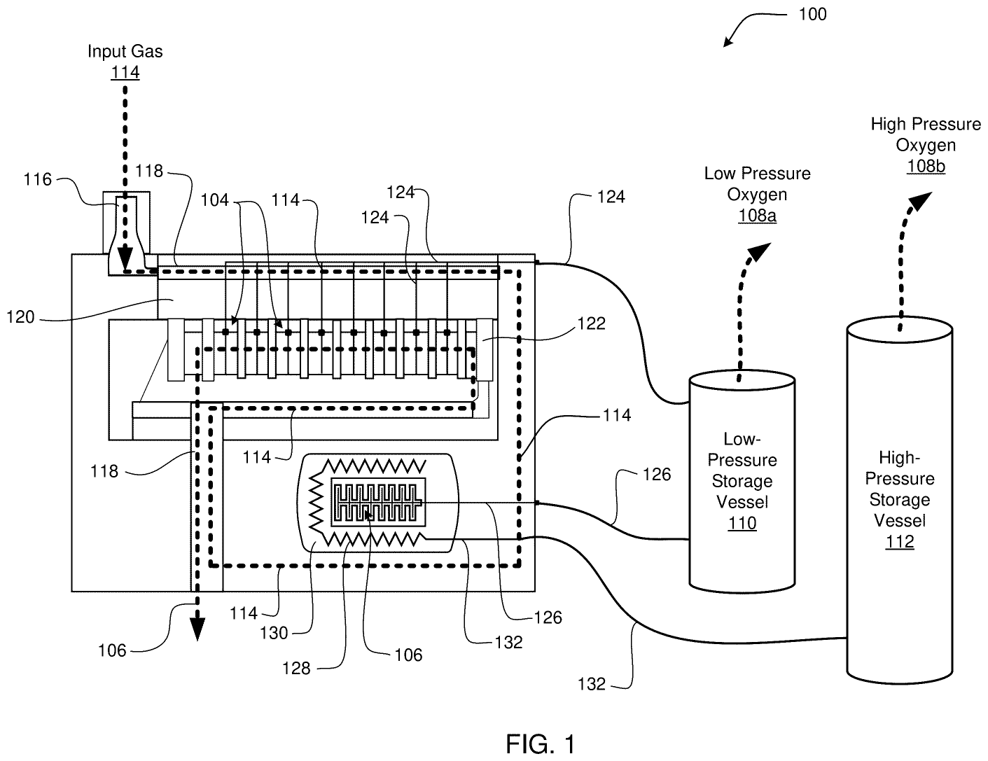

Referring now to the figures, FIG. 1 is a schematic illustration of a system 100 for two-stage oxygen concentration, purification, and compression. The system 100 includes an oxygen concentration and a compression system 100 that includes a first stage oxygen concentrator and a second stage oxygen concentrator. In the example embodiment illustrated in FIG. 1, the first stage oxygen concentrator comprises a first-stage electrochemical stack 104, although this is not required. In alternative embodiments, the first stage oxygen concentrator may include any other means of purifying, separating, or concentrating oxygen. Further in the example embodiment illustrated in FIG. 1, the second stage oxygen concentrator includes a second-stage electrochemical stack 106.

In the example implementation illustrated in FIG. 1, the first stage oxygen concentrator and the second stage oxygen concentrator are disposed within the same housing. In alternative implementations, the first and second stage oxygen concentrators may be disposed within different housings or may be located in different geographic locations.

The system 100 includes a low-pressure storage vessel 110 and a high-pressure storage vessel 112. The system 100 outputs high purity oxygen, including low-pressure oxygen 108a output by a first stage of the system 100, and high-pressure oxygen 108b output by a second stage of the system 100 (the oxygen gas may generally be referred to as oxygen gas 108 as discussed herein). The “low-pressure” high purity oxygen 108a is still pressurized and is only considered “low-pressure” relative to the high-pressure oxygen 108b output by the second stage of the system 100.

The low-pressure oxygen 108a is high purity oxygen gas that has been concentrated with the first stage oxygen concentrator of the system 100. The system 100 then further concentrates and further pressurizes the oxygen gas, such that the high-pressure oxygen 108b has increased purity when compared with the low-pressure oxygen 108a.

The system 100 begins with a first stage of oxygen concentration and compression. In the example illustrated in FIG. 1, the first stage oxygen concentration is executed the first electrochemical stack 104, which includes a plurality of electrochemical cells arranged in series as shown in FIG. 1. The first electrochemical stack 104 receives an input gas 114 and outputs and low-pressure oxygen gas 108a. The low-pressure oxygen gas 108 is then carried to the low-pressure storage vessel 110 and is stored therein. The system 100 receives the input gas 114 at a first stage inlet port 116. The first stage inlet port 116 may include a blower for pushing the input gas 114 into the system 100. The input gas 114 is any oxygen-containing gas and may specifically include air.

After passing through the first stage inlet port 116, the input gas 114 is pushed into a region comprising insulation 120. The input gas 114 may specifically be pushed into an input gas conduit 118 that is disposed within and surrounded by the insulation 120. The input gas 114 is heated as it passes through the insulation 120 and thus creates heated input gas 114. The heated input gas 114 is fed into an oxygen concentration inlet region 122 wherein the heated input gasNP 114 is taken up by one or more of the series of the first electrochemical stack 104. In the example illustrated in FIG. 1, the heated input gas 114 is continually heated as it passes through the insulation 120 and around the second electrochemical stack 106 prior to being fed into the concentration inlet region 122.

In the example depicted in FIG. 1, the first electrochemical stack 104 includes a series of eight electrochemical stacks arranged in series. Each of the eight electrochemical stacks comprises a plurality of electrochemical cells, which may alternatively be referred to as wafers as described herein. The system 100 may include any number of electrochemical stacks. In some cases, the first stage oxygen concentrator will include only one electrochemical stack. The series of the first electrochemical stack 104 retrieves oxygen from the heated input gas 114 and outputs the low-pressure oxygen 108a through a first stage oxygen outlet pipeline 124. As shown in FIG. 1, each of the individual first electrochemical stacks 104 includes a first stage oxygen outlet pipeline 124, and the collection of the first stage oxygen outlet pipelines 124 eventually feed into the low-pressure storage vessel 110. The low-pressure oxygen gas 108a may be retrieved and utilized directly from the low-pressure storage vessel 110 as shown in FIG. 1.

The system 100 continues with a second stage of oxygen concentration and compression. The second stage is executed by the second electrochemical stack 106, which may include a series of a plurality of electrochemical stacks as shown in FIG. 1. The second electrochemical stack 106 receives the low-pressure oxygen 108a as an input. The low-pressure oxygen 108a is fed to the second electrochemical stack 106 directly from the low-pressure storage vessel 110 as shown in FIG. 1. The second electrochemical stack 106 outputs high-pressure oxygen gas 108b that is then stored in the high-pressure storage vessel 112.

The second stage oxygen concentrator receives the low-pressure oxygen gas 108a as an input from the low-pressure storage vessel 110 by way of a second stage inlet pipeline 126. The second stage inlet pipeline 126 feeds the low-pressure oxygen 108a through a series of electrochemical stacks making up the second electrochemical stack 106. The second electrochemical stacks 106 are heated by a heating element 128 and surround by a collection region 130 that receives high-pressure oxygen gas 108b output by the series of the second electrochemical stacks 106. The high-pressure oxygen gas 108b is output through a second stage oxygen outlet pipeline 132 that feeds into the high-pressure storage vessel 112.

Alternatively, the oxygen concentration and compression system 100 may be split into two separate systems and two separate enclosures wherein the first-stage system is located in a first enclosure, and the second-stage system is located in a second enclosure, and the second-stage system may receive oxygen gas 108a from the first-stage system and produce higher concentration and higher-pressure oxygen gas 108b. A two-stage system with two separate enclosures is not shown in FIG. 1.

The low-pressure storage vessel 110 may be configured with a maximum pressure of about 200 pounds per square inch gauge (psig). The low-pressure storage vessel 110 may be configured with a maximum pressure from about 5 psig to about 150 psig. The high-pressure storage vessel 112 may be configured with a maximum pressure of about 10,000 psig. The high-pressure storage vessel 112 may be configured with a maximum pressure from about 200 psig to about 10,000 psig depending on the implementation. It should be understood that the pressurizations of the low-pressure storage vessel 110 and the high-pressure storage vessel 112 may vary depending on the implementation. As discussed herein, the “low-pressure” high purity oxygen gas 108a is stored at a moderate pressure and is only referred to as “low-pressure” herein because it is output and stored at a lower pressure relative to the high-pressure oxygen gas 108b.

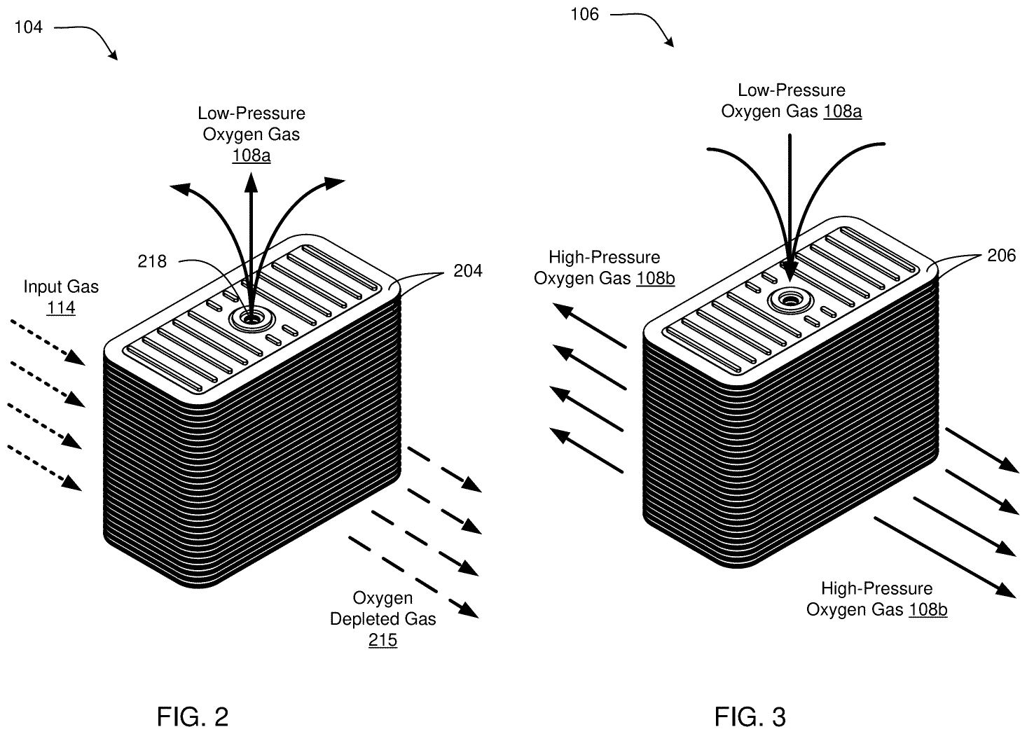

FIGS. 2 and 3 are perspective views of example electrochemical stacks, including the first electrochemical stack 104 illustrated in FIG. 2 and the second electrochemical stack 106 illustrated in FIG. 3. Each electrochemical stack 104, 106 is constructed of a plurality of wafers 204, 206 which will be discussed further herein. The first electrochemical stack 104 includes a first configuration for the wafers, which are denoted as wafers 204 as discussed herein. The second electrochemical stack 106 includes a second configuration for the wafers, which are denoted as wafers 206 as discussed herein.

The first electrochemical stack 104 receives the input gas 114 as it passes through the electrochemical stack 104 and between the wafers 204. The oxygen depleted gas 215 exits the electrochemical stack 104 on the opposite side. The low-pressure oxygen gas 108 is captured at an oxygen exhaust port as shown in FIG. 2.

The second electrochemical stack 106, which is responsible for further concentrating and pressuring oxygen during the second stage of the system 100, receives the low-pressure oxygen gas 108a as an input. As shown in FIG. 3, the second electrochemical stack 106 operates under a reversed configuration, wherein the input gas (in this case, the low-pressure oxygen gas 108a) is received through the center port disposed through the electrochemical stack 106. The high-pressure oxygen gas 108b then exits the second electrochemical stack 106 through all sides.

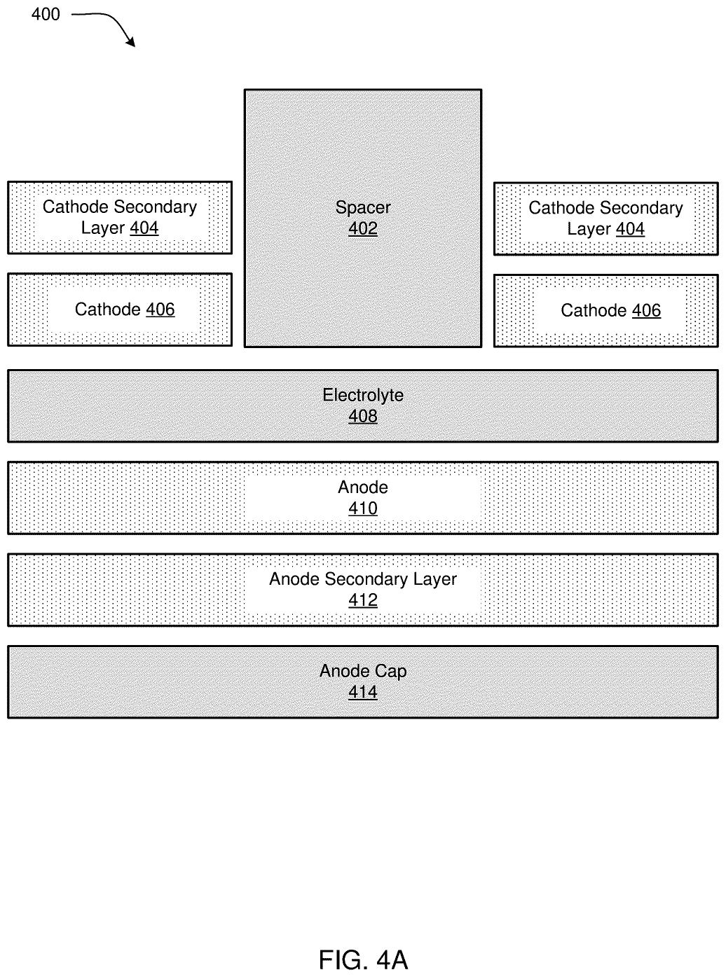

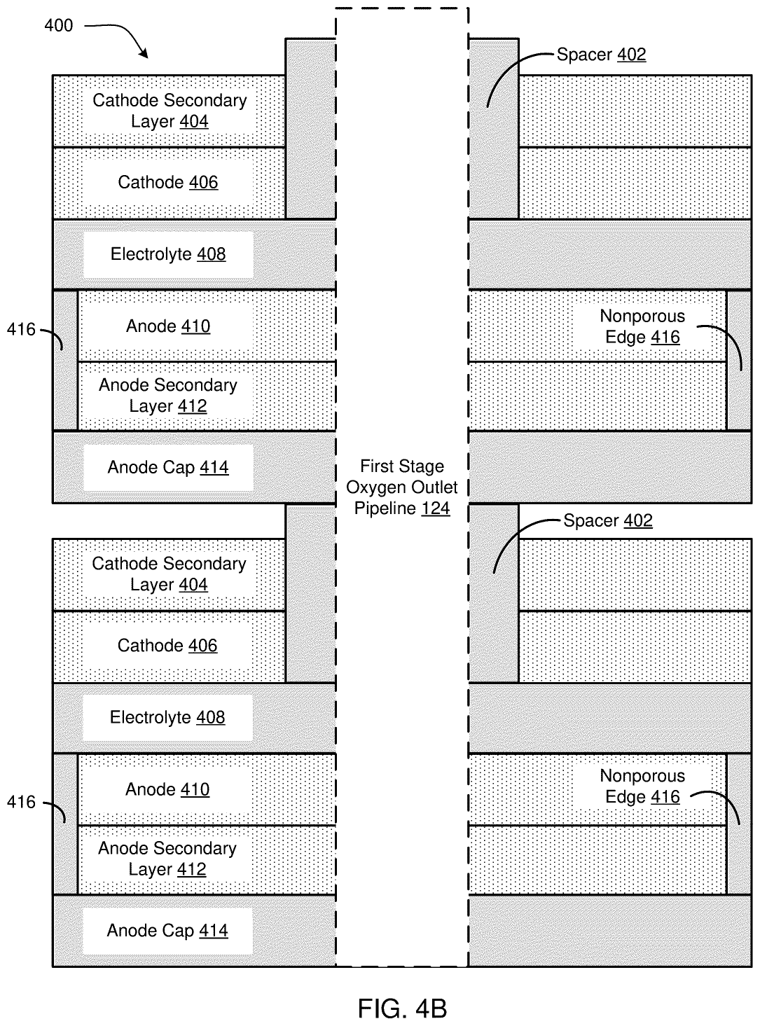

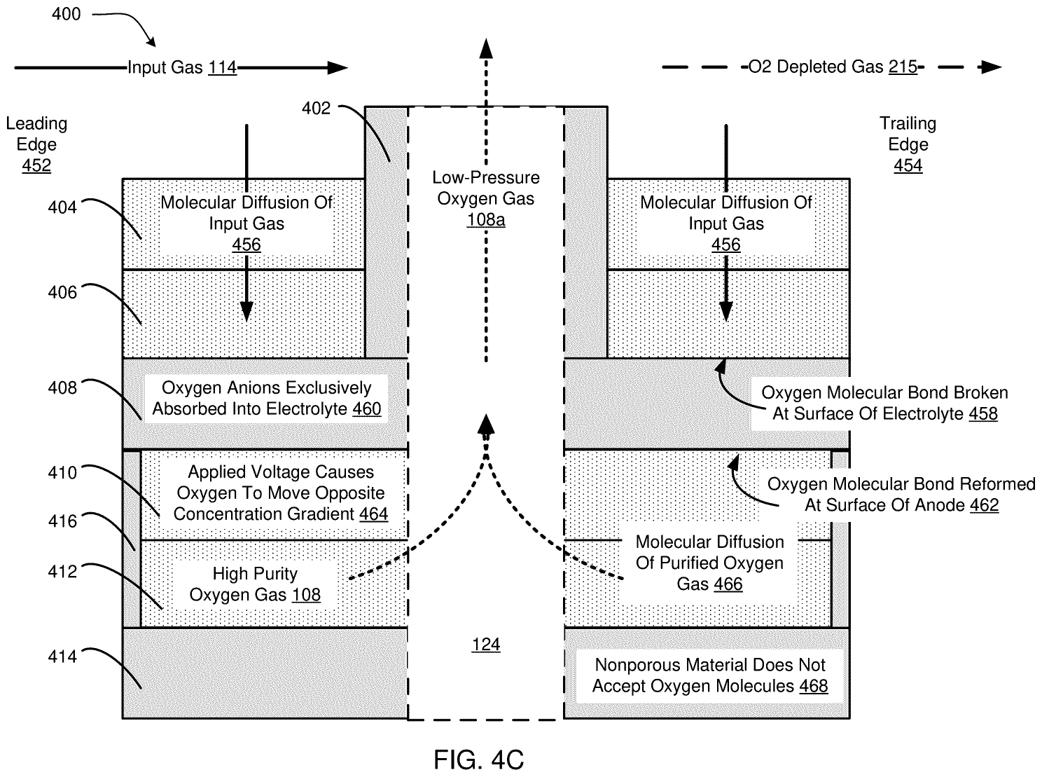

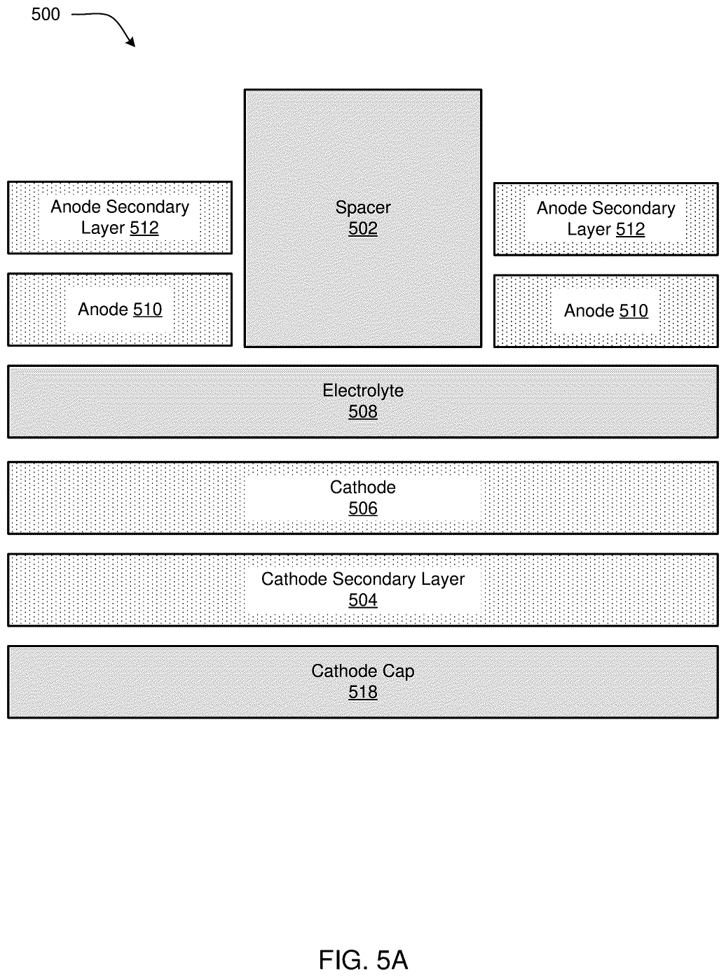

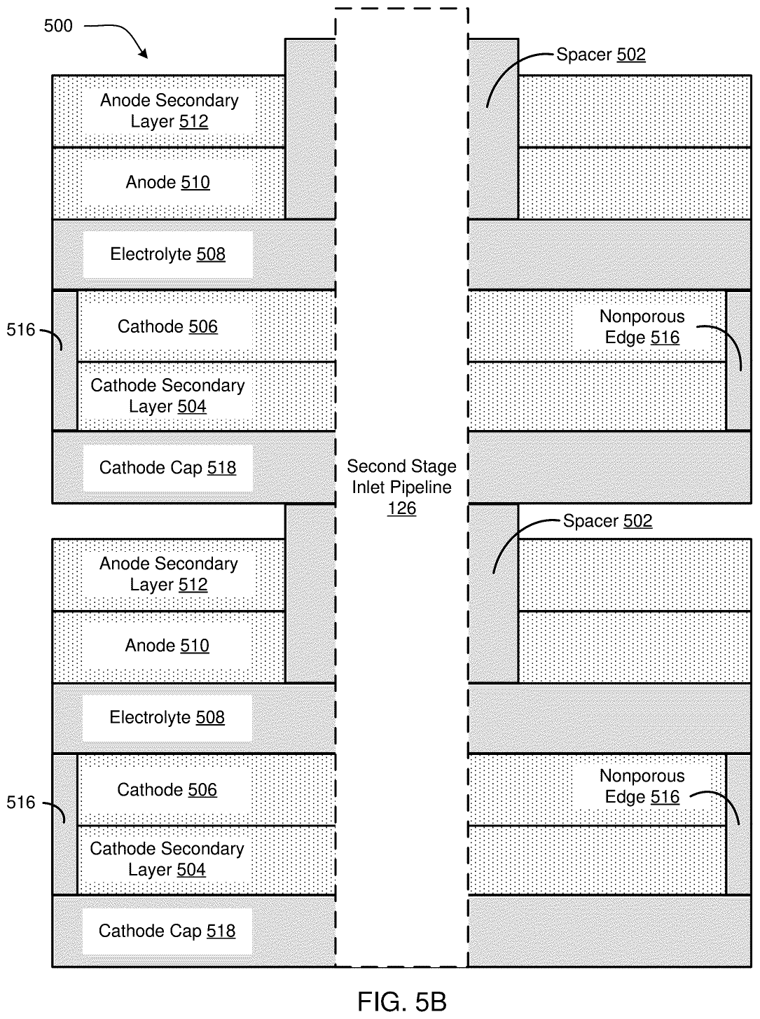

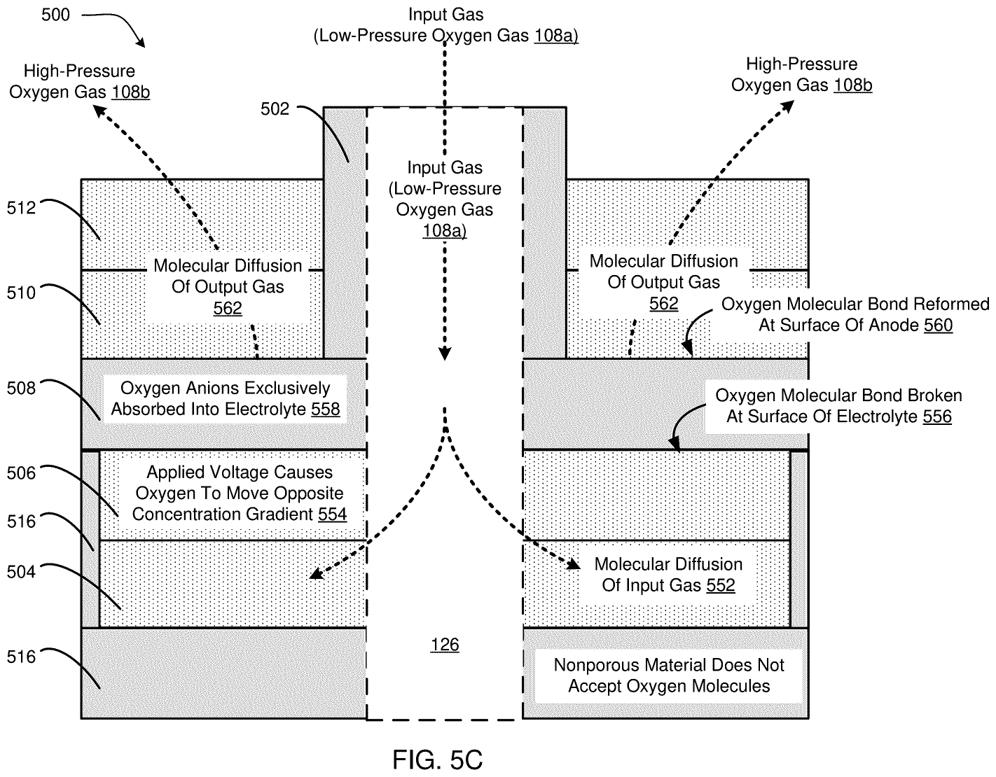

FIGS. 4A-4C are schematic illustrations of components of the wafers 204 of first electrochemical stack 104, and FIGS. 5A-5C are schematic illustrations of components of the wafers 206 of the second electrochemical stack 106. As shown in FIGS. 4A-4C and 5A-5C, the first electrochemical stack 104 and the second electrochemical stack 106 include the same components but in different configurations. The second electrochemical stack 106 may be referred to as the reverse configuration relative to the first electrochemical stack 104.

FIG. 4A is a schematic diagram of an exploded view of a layering scheme 400 for a single wafer 204 within the first electrochemical stack 104. The layering scheme 400 includes a spacer 402, a cathode secondary layer 404, a cathode 406, an electrolyte 408, an anode 410, an anode secondary layer 412, and an anode cap 414. The layering scheme 400 depicted in FIG. 4A is illustrative only. Certain layers may have a larger or smaller surface area than other layers and/or a larger or smaller thickness than other layers and/or each of the layers may be secured or bonded to surrounding layers. Each of the layers may be co-sintered during manufacture such that the layers 402-414 are bonded.

The spacer 402 provides a gap between two wafers in the first electrochemical stack 104. As illustrated in FIG. 2, for example, there is a spacer 402 on each wafer 204 such that there is a gap between each of the plurality of wafers in the first electrochemical stack 104. The gap enables the input gas 114 to enter at the leading edge of a wafer 204 and further enables the oxygen depleted gas 215 to exit at the trailing edge of the wafer 204 . The spacer 402 surrounds an oxygen exhaust port (see 218) that provides an outlet for high purify oxygen gas 108a to exit the first electrochemical stack 104.

In an embodiment, the spacer 402 is co-sintered with the remaining layers 404-414 of the wafer 204. This is an improvement over other membrane-based oxygen concentration technologies known in the art where the spacer 402 is secured to the remaining layers of the wafer 204 during assembly of the first electrochemical stack 104. There are numerous benefits to the spacer 402 being co-sintered with the remaining layers 404-414 of the wafer 204. The spacer 402 provides a gastight seal with the anode cap 414 of a different wafer 204 located above the spacer 402, and the spacer 402 further provides a gastight seal with the electrolyte layer 408 of the same wafer 204 . When the spacer 402 is co-sintered with the remaining layers 404-414 of the wafer 204, the gastight seal between the spacer 402 and the electrolyte layer 408 is structurally more rigid and provides an improved nonporous seal. There are numerous challenges associated with co-sintering the spacer 402 with the remaining layers 404-414. One such challenge is that the sintering process may cause the spacer 402 to curl and separate from the remaining layers 404-414 due to differences in thickness, shape, and materials.

The cathode secondary layer 404 is a porous material and is configured to receive the input gas 114. The input gas 114 is passed over the first electrochemical stack 104 and over each wafer 204 within the first electrochemical stack 104. In an embodiment, the input gas 114 is blown into the first electrochemical stack 104. Molecular diffusion causes the input gas 114 to enter the cathode secondary layer 404. The cathode 406 is a porous material and is configured to receive the input gas 114 after the input gas 114 has passed through the cathode secondary layer 404. Molecular diffusion causes the input gas 114 to enter the cathode 406. The cathode 406 makes direct contact with the electrolyte 408.

The electrolyte 408 is a specialized ceramic material configured to receive oxygen ions. The electrolyte 408 is nonporous when compared with the cathode secondary layer 404, cathode 406, anode 410, or anode secondary layer 412. As described herein, the electrolyte 408 may be referred to as “nonporous,” but it should be appreciated that the electrolyte 408 may still have some unavoidable porosity due to its inherent ceramic properties. The electrolyte 408 may specifically be described as having no through-porosity such that the electrolyte 408 does not permit molecular diffusion across the electrolyte 408 layer but will permit diffusion of oxygen ions across the electrolyte 408 layer. There are oxygen atom deficiencies throughout the crystal structure of the electrolyte 408. The electrolyte 408 will not permit diffusion of ions other than oxygen ions (O²⁻). The input gas 114 located within the cathode 406 may include oxygen molecules (O₂). A voltage is applied to the first electrochemical stack 104 that enables a reduction reaction to occur to the oxygen molecules (O₂) at the surface of the electrolyte 408. The reduction reaction follows Equation 1, below.

O₂+4e⁻→2O²⁻ Equation 1

The reduction of the oxygen molecules (see Equation 1) occurs at the surface of the electrolyte 408, and it may also occur in the cathode 406 in close proximity to the electrolyte 408. The reduction of one oxygen molecule results in two oxygen ions. The two oxygen ions are accepted by the electrolyte 408 to fill oxygen deficiencies within the crystal lattice structure of the electrolyte 408 ceramic material. Oxygen ions travel within the crystal lattice structure of the electrolyte 408, and possibly along grain boundaries of electrolyte 408, and are eventually oxidized at the surface of the anode 410 according to Equation 2, below.

2O²⁻→O₂+4e⁻ Equation 2

The anode 410 is a porous material that accepts the oxygen molecules (O₂). During operation, a voltage, or EMF is applied to the first electrochemical stack 104. Because of the EMF, the oxygen molecules created according to Equation 2 near the anode-side of the electrolyte 408 may be consumed by the anode 410 even when the oxygen molecules are travelling from the electrolyte 408 to the anode 410 against a concentration gradient. Because the electrolyte 408 lacks through-porosity and will only accept oxygen ions, the anode 410 and anode secondary layer 412 may only consume pure oxygen. The electrolyte 408 is such that there are no non-oxygen molecules or ions traveling through the electrolyte 408 crystal lattice structure that may eventually reach the surface of the anode 410. The anode secondary layer 412 is a porous material that holds the high purity oxygen gas that is received by the anode 410.

The anode cap 414 is a nonporous material that prevents the high purity oxygen gas from traveling beyond the anode secondary layer 412. There is a hole running through each of the layers 402-414 such that the high purity oxygen gas may only travel through the hole and be harvested by the system.

FIG. 4B is a schematic diagram of a cross-sectional view of the layering scheme 400 depicted in FIG. 4A. FIG. 4B shows two wafers 204 stacked on top of each other, with each wafer 204 including each of the layers 402-414 depicted in FIG. 4A. As shown in FIG. 4B, the cathode secondary layer 404 and the cathode 406 have a hole approximately the size of the outside diameter of the spacer 402 such that the spacer 402 extends to the upper surface of the electrolyte 408. Each of the layers 402-414 includes a hole forming a first stage oxygen outlet pipeline 124 where high purity oxygen gas travels to exit the system. In an embodiment, a first electrochemical stack 104 includes the first stage oxygen outlet pipeline 124 running through each wafer 204 along the length of the first electrochemical stack 104.

The spacer 402 extends to the electrolyte 408 to prevent contamination of the high purity oxygen gas that is traveling in the first stage oxygen outlet pipeline 124. The spacer 402 is nonporous and does not permit any molecules or ions to pass through. The cathode secondary layer 404 and the cathode 406 each consume input gas 114 that includes oxygen along with other contaminants such as nitrogen, argon, and other particles. The nonporous spacer 402 prevents the other contaminants from exiting the cathode secondary layer 404 and/or the cathode 406 and entering the first stage oxygen outlet pipeline 124. The first stage oxygen outlet pipeline 124 only includes high purity oxygen gas.

The anode cap 414 is nonporous and provides a barrier similar to that provided by the spacer 402. The anode cap 414 prevents contaminants, such as nitrogen, argon, or other particles, from entering the first stage oxygen outlet pipeline 124. Further, the anode cap 414 prevents the high purity oxygen gas that is located within the anode 410 and/or the anode secondary layer 412 from exiting the system 100 and reentering the atmosphere. The high purity oxygen gas is located within the anode 410 and the anode secondary layer 412. The interior edges (i.e., the edge along the first stage oxygen outlet pipeline 124) of the anode 410 and/or the anode secondary layer 412 are open such that the high purity oxygen gas may exit and enter the first stage oxygen outlet pipeline 124. The high purity oxygen gas exits the system by way of the first stage oxygen outlet pipeline 124 where it may eventually be used on-site or harvested in a tank or other vessel, such as the low-pressure storage vessel 110.

As shown in FIG. 4B, each of the anode 410 and the anode secondary layer 412 includes a nonporous edge 416. The nonporous edge 416 surrounds the perimeter of the anode 410 and the anode secondary layer 412. The nonporous edge 416 prevents the high purity oxygen gas from exiting either of the anode 410 and/or the anode secondary layer 412 and reentering the atmosphere. The nonporous edge 416, along with the electrolyte 408 and the anode cap 414, forces the high purity oxygen gas to exit the system by way of the first stage oxygen outlet pipeline 124.

FIG. 4C is a schematic diagram of a cross-sectional view of the layering scheme 400 further depicting the pathways of the input gas 114, oxygen depleted gas 215, low-pressure oxygen gas 108a, oxygen ions, and oxygen molecules. Each of the wafers 204 includes a leading edge 452 and a trailing edge 454. The input gas 114 passes over the wafer 204 starting with the leading edge 452 and ending with the trailing edge 454. In an embodiment, the input gas 114 is passes over the wafer 204 beginning with the leading edge 452. Input gas 114 enters the wafer 204 at the cathode secondary layer 404. Molecular diffusion causes the input gas 114 to pass into the porous cathode secondary layer 404 at 456 until it reaches electrolyte layer 408. Molecular diffusion causes the molecules of the input gas 114 to travel through the cathode secondary layer 404 and the cathode 406. The spacer 402 prevents the molecules of the input gas 114 from entering the first stage oxygen outlet pipeline 124.

The oxygen molecules are reduced (see Equation 1) near the surface and at the surface of the electrolyte 408 where the oxygen molecular bond is broken at 458. The crystal structure of the electrolyte 408 has oxygen deficiencies and causes the oxygen ions to travel through the electrolyte 408. The electrolyte 408 exclusively accepts oxygen ions at 460. At the opposite end of the electrolyte 408 at the surface of the anode 410, the oxygen ions are oxidized (see Equation 2) and the oxygen molecular bond is reformed at 462. A voltage or EMF is applied to the first electrochemical stack 104 and this EMF causes the oxygen molecules to form near the surface of the anode 410 as shown at 462, even if there exists a high concentration of oxygen molecules in the anode 410 and the anode secondary layer 412. The anode 410 and the anode secondary layer 412 include only high purity oxygen gas. The nonporous anode cap 414 prevents the high purity oxygen gas from exiting the system and reentering the atmosphere at 468. Molecular diffusion causes the high purity oxygen gas to leave the anode 410 and/or the anode secondary layer 412 to enter the first stage oxygen outlet pipeline 124 at 466. The nonporous edge 416 prevents the high purity oxygen gas from exiting the anode 410 and/or the anode secondary layer 412 and reentering the environment. The high purity oxygen gas may travel the length of the first electrochemical stack 104 up the first stage oxygen outlet pipeline 124 where it may eventually be used on-site or harvested in a tank or other vessel.

As the system is operating, the high purity oxygen gas within the anode 410 and/or the anode secondary layer 412 builds pressure. Further, the input gas 114 within the cathode 404 and/or the cathode secondary layer 406 exists at one atmosphere of pressure when operating at sea level at ambient conditions. In an instance where the input gas 114 is air, the input gas 114 includes approximately 21% oxygen. In this instance, where high purity oxygen gas exists at some pressure within the anode and gas comprising 21% oxygen exists within the cathode at one atmosphere of pressure, the concentration gradient would push oxygen gas to the cathode where there is less concentration of oxygen. However, the voltage applied to the system causes the oxygen to move opposite the concentration gradient to exit the electrolyte 460 and enter the anode at 464.

FIGS. 5A-5C illustrate layering schemes 500 for wafers 206 of the second electrochemical stack 106. The second electrochemical stack 106 includes the same components as the first electrochemical stack 104. However, the second electrochemical stack 106 is reconfigured to enable the input gas (in this case, the low-pressure oxygen gas 108a) to be fed into the center port through a tube, rather than passed over the exterior surfaces of the wafers 204 like the first electrochemical stack 104.

FIG. 5A is a schematic illustration of the layering scheme 500 for the wafers 206 of the second electrochemical stack 106. The positioning of the anodes and the cathodes are reversed when compared against the layering scheme 400 for the wafers 204 of the first electrochemical stack 104. The wafers 206 include a spacer 502, anode secondary layer 512, anode 510, electrolyte 508, cathode 506, cathode secondary layer 504, and cathode cap 518.

FIG. 5B is a schematic illustration of a cross-sectional view of the layering scheme 500 depicted in FIG. 5A. FIG. 5B shows two wafers 206 stacked on top of one another, with each wafer 206 including each of the layers 502-512, 518 depicted in FIG. 5A. Similar to the layering scheme 400 illustrated in FIG. 4B, the anode secondary layer 512 and the anode 510 each have a hole disposed therethrough that is approximately the size of the outside diameter of the spacer 502 such that the spacer 502 extends to the upper surface of the electrolyte 508. Each of the layers 502-512, 518 includes a hole disposed therethrough forming a portion of the second stage inlet pipeline 126 wherein the low-pressure oxygen gas 108a is received by the wafers 206 of the second electrochemical stack 106.

Like the layering scheme 400 discussed in connection with the first electrochemical stack 104, the spacer 502 is nonporous and does not permit any molecules are ions to pass through. The cathode secondary layer 504 and the cathode 506 each consume input gas, which in this case, includes the low-pressure oxygen gas 108a. Each of the cathode 506 and the cathode secondary layer 504 includes nonporous edge 516. The nonporous edge 516 prevents the input low-pressure oxygen gas 108a from exiting the second electrochemical stack 106 through either of the cathode 506 and/or the cathode secondary layer 504. This prevents the input low-pressure oxygen gas 108a from comingling with the high-pressure oxygen gas 108b that is further concentrated and pressurized by the second electrochemical stack 106.

FIG. 5C is a schematic diagram of a cross-sectional view of the layering scheme 500 further depicting the pathways of the input low-pressure oxygen gas 108a, the output high-pressure oxygen gas 108b, the oxygen ions, and the oxygen molecules. The second electrochemical stack 106 receives purified oxygen gas that was previously concentrated by the first electrochemical stack 104. Alternatively, the second electrochemical stack 106 may receive majority oxygen gas from an oxygen supply or source that is not a first electrochemical stack 104 such as from a PSA oxygen concentrator device. The second electrochemical stack 106 further purifies and pressurizes the input low-pressure oxygen gas 108a and outputs the further concentrated high-pressure oxygen gas 108b.

The second electrochemical stack 106 receives the input low-pressure oxygen gas 108a by way of the second stage inlet pipeline 126. The second stage inlet pipeline 126 includes the hole disposed through the center of the second electrochemical stack 106, which is like the first stage oxygen outlet pipeline 124 disposed through the first electrochemical stack 104. The input gas undergoes molecular diffusion at 552 across the cathode secondary layer 504 and/or the cathode 506. Then, an applied voltage or EMF causes oxygen from the input gas to move along the concentration gradient at 554. The electrolyte 508 breaks the oxygen molecular bonds (see Equation 1) of the input gas at 556. The oxygen anions are exclusively absorbed by the electrolyte 508 at 558. The oxygen molecular bond is then reformed at the surface of the anode 510 at 560. Then, the reformed oxygen molecules undergo molecular diffusion at 562 across the anode 510 and anode secondary layer 512. The output gas, which in this case, consists of the high-pressure oxygen gas 108b, then exits the second electrochemical stack 106 by diffusing through the anode 510 and/or the anode secondary layer 512.

The high-pressure oxygen gas 108b is further purified relative to the low-pressure oxygen gas 108a output by the first electrochemical stack 104. Additionally, the second electrochemical stack 106 further pressurizes the low-pressure oxygen gas 108. The output high-pressure oxygen gas 108b accumulates within the collection region 130 of the system 100 and is then fed through the second stage oxygen outlet pipeline 132 to the high-pressure storage vessel 112.

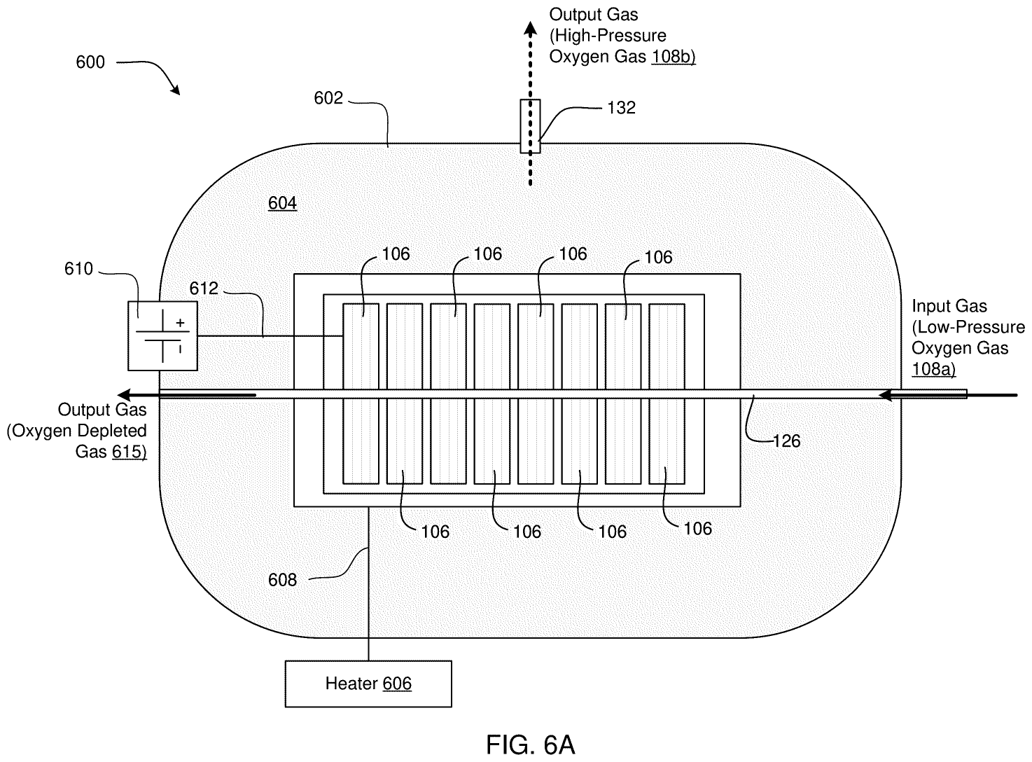

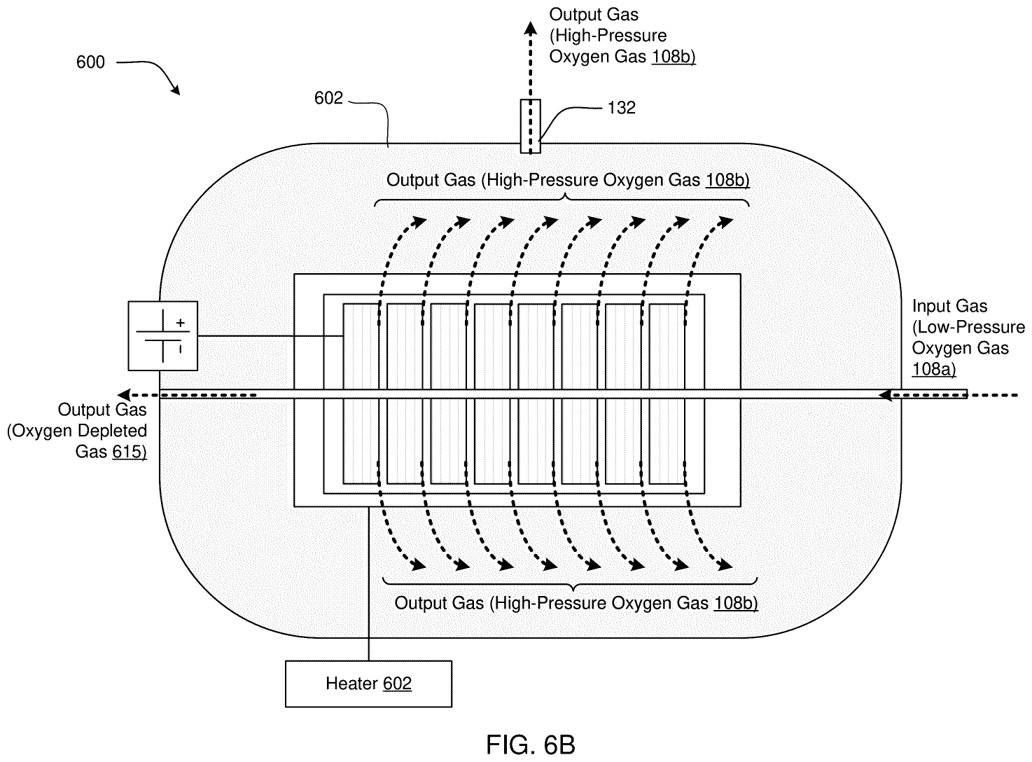

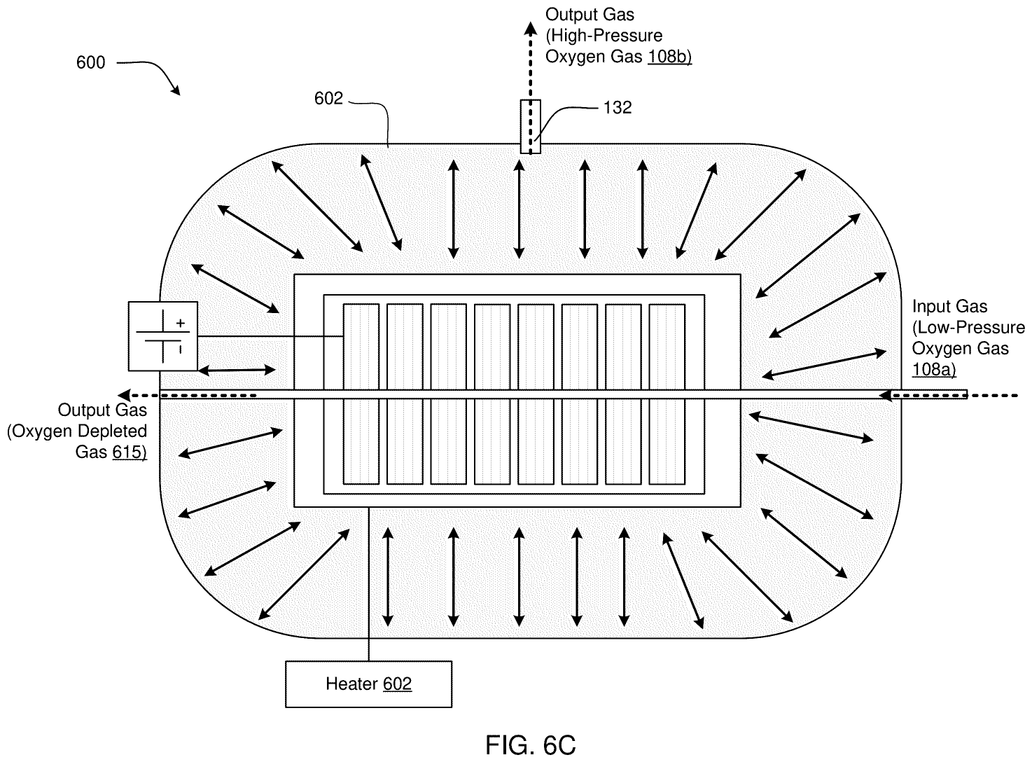

FIGS. 6A-6C are schematic illustrations of cross-sectional view of a system 600 for concentrating and pressurizing oxygen gas. The system 600 may be implemented within the system 100 as the second stage oxygen concentrator and purifier. FIG. 6A illustrates a cross-sectional view of components of the system 600. FIG. 6B illustrates a cross-sectional view of the system 600 that depicts the release of high-pressure oxygen gas 108b from the electrochemical stacks 106 into an interior region of the housing. FIG. 6C illustrates a cross-sectional view of the system 600 that depicts the development of increased pressure within the housing as the high-pressure oxygen gas 108b is released by the electrochemical stacks 106.

The system 600 includes a housing 602 disposed around a series of a plurality of units of the second electrochemical stack 106. In the example illustrated in FIGS. 6A-6C, the system 600 includes eight units of the second electrochemical stack 106, wherein each of the second electrochemical stacks 106 includes a plurality of wafers 206. The electrochemical stacks 106 are surrounded by thermal insulation 604. The insulation 604 may specifically include non-flammable and porous insulation.

The system 600 includes a heater 606 configured to heat the electrochemical stacks 106. The heater 606 provides heat to the electrochemical stacks 106 by way of a heater cable 608. In the examples illustrated in FIGS. 6A-6C, there exists a single heater cable 608 providing heat to the electrochemical stacks 106, but it should be appreciated that the system 600 may include any number of heater cables 608 as needed, and the heater 606 may be located inside housing 602 or outside housing 602, or a combination of both.

The system 600 includes a battery or direct current (DC) power supply 610 in communication with the electrochemical stacks 106. The battery or DC power supply 610 provides a voltage or EMF that causes oxygen to move through the cathode 506 to the electrolyte 508 (see step 554 discussed in connection with FIG. 5C). The battery 610 may specifically include a direct current (DC) power supply, with two or more battery cables 612 providing the voltage to the electrochemical stacks 106. The battery 610 may be in communication with one or more positive terminal battery cables 612 and one or more negative terminal battery cables to provide the DC voltage to the electrochemical stacks 106.

As shown in FIG. 6A, the system 600 receives an input gas by way of the second stage inlet pipeline 126. The input gas may specifically include the low-pressure oxygen gas 108a that was concentrated and pressurized by the first stage of the system 100. The low-pressure oxygen gas 108a may be provided from a low-pressure storage vessel 110 as shown in FIG. 1. The input gas passes through the central hole disposed through each of the wafers 206 of the electrochemical stacks 106. The output oxygen depleted gas 615 continues through the electrochemical stacks 106 and exits the housing 602 through a pipe or channel in gaseous communication with the second stage inlet pipeline 126 as shown in FIGS. 6A-6C. In an example implementation, the input gas is pressurized at least to 0.1 psig, and includes at least 50-percent oxygen. It should be appreciated that the input gas may include any gas comprising oxygen and does not necessarily need to include the gas that was previously concentrated and pressurized by the first stage of the system 100.

FIG. 6B depicts the output of the high-pressure oxygen gas 108b. The output high-pressure oxygen gas 108b is released from the anodes 510 and/or anode secondary layers 512 of electrochemical stacks 106 by way of molecular diffusion (see step 562 discussed in connection with FIG. 5C). The output high-pressure oxygen gas 108b then accumulates within the housing 602.

FIG. 6C depicts the accumulation of pressure within the housing 602. The double arrowed lines represent the increased pressure that mounts within the housing 602 as the electrochemical stacks 106 continue to output the high-pressure oxygen gas 108b. The high-pressure oxygen gas 108b becomes increasingly pressurized until the high-pressure oxygen gas 108b is permitted to exit the housing 602 by way of the second stage oxygen outlet pipeline 132.

The electrochemical stacks 106 continuously release output gas (i.e., the high-pressure and highly purified oxygen gas 108b) into an interior space defined by the housing 602. This places the electrochemical stacks 106 into isostatic compression. The compressed oxygen gas within the housing 602 applies isostatic uniform compression on the electrochemical stacks 106 and applies uniform outward pressure on an inside surface of the 602, as shown in FIG. 6C. The pressure within the housing 602 may be continuously increased to a breaking point of the components within the housing 602, including the electrochemical stacks 106 themselves. In some implementations, the pressure within the housing may be increased up to about 10,000 psig.

### EXAMPLES

The following examples pertain to further embodiments.

Example 1 is a system for concentrating oxygen gas. The system includes a plurality of wafers. Each wafer of the plurality of wafers comprises a spacer, a cathode, an electrolyte, an anode, and an anode cap, wherein the spacer is in contact with the electrolyte. Each wafer 204 further comprises a hole disposed therethrough configured for providing an oxygen exhaust port. The electrolyte comprises a ceramic having oxygen ion deficiencies such that the electrolyte is configured for exclusively accepting oxygen ions.

Example 2 is a system as in Example 1, wherein the cathode and the anode comprise a

porous material.

Example 3 is a system as in any of Examples 1-2, wherein the spacer, the electrolyte and the anode cap comprise a nonporous material.

Example 4 is a system as in any of Examples 1-3, wherein the wafer 204 further comprises a cathode secondary layer, and wherein the cathode secondary layer and the cathode comprise a porous material configured for accepting an input gas comprising oxygen.

Example 5 is a system as in any of Examples 1-4, further comprising an electricity source in electrical communication with each wafer 204 of the plurality of wafers such that an electric potential is applied to the electrochemical stack, wherein a surplus of electrons exists at the cathode.

Example 6 is a system as in any of Examples 1-5, wherein the surplus of electrons at the cathode causes oxygen molecules in the input gas to undergo a reduction reaction such that one oxygen molecule generates two oxygen ions.

Example 7 is a system as in any of Examples 1-6, wherein a deficiency of electrons exists at the anode, wherein the deficiency of electrons at the anode causes oxygen ions to undergo an oxidation reaction such that two oxygen ions generate one oxygen molecule, wherein the oxygen exhaust port is configured for receiving the one oxygen molecule.

Example 8 is a system as in any of Examples 1-7, wherein the wafer 204 comprises a rectangular shape comprising a width and a height, wherein the width is longer than the height.

Example 9 is a system as in any of Examples 1-8, wherein the wafer 204 comprises one or more curved edges.

Example 10 is a system as in any of Examples 1-9, wherein the wafer 204 comprises one or more curved sides.

Example 11 is a system as in any of Examples 1-10, wherein the spacer is co-sintered with one or more other layers of the wafer 204 such that the spacer is secured to the anode cap, or alternatively secured to the electrolyte.

Example 12 is a system as in any of Examples 1-11, wherein the wafer 204 further comprises ribbing.

Example 13 is a system as in any of Examples 1-12, wherein the ribbing is co-sintered with one or more other layers of the wafer 204 such that the ribbing is secured to the anode cap.

Example 14 is a system. The system includes a first stage oxygen concentrator and purifier. The system includes a second stage oxygen concentrator and purifier. The first stage oxygen concentrator and purifier outputs a first oxygen output gas. The second stage oxygen concentrator and purifier receive the first oxygen output gas as a second input gas.

Example 15 is a system as in Example 14, wherein the first stage oxygen concentrator and purifier comprise one or more of a first electrochemical stack.

Example 16 is a system as in any of Examples 14-15, wherein the second stage oxygen concentrator and purifier comprise one or more of a second electrochemical stack.

Example 17 is a system as in any of Examples 14-16, wherein each of the first electrochemical stack and the second electrochemical stack comprises an anode, a cathode, and an electrolyte.

Example 18 is a system as in any of Examples 14-17, wherein each of the first electrochemical stack and the second electrochemical stack further comprises an anode secondary layer and a cathode secondary layer.

Example 19 is a system as in any of Examples 14-18, wherein one of the first electrochemical stack or the second electrochemical stack comprises an anode cap.

Example 20 is a system as in any of Examples 14-19, wherein one of the first electrochemical stack or the second electrochemical stack comprises a cathode cap.

Example 21 is a system as in any of Examples 14-20, wherein the first electrochemical stack receives a first input gas comprising oxygen.

Example 22 is a system as in any of Examples 14-21, wherein the first input gas is air.

Example 23 is a system as in any of Examples 14-22, wherein the first electrochemical stack outputs a first oxygen-depleted gas and further outputs the first oxygen output gas.

Example 24 is a system as in any of Examples 14-23, wherein the second electrochemical stack receives the first oxygen output gas, and wherein the second electrochemical stack outputs a second oxygen-depleted gas and further outputs a second oxygen output gas.

Example 25 is a system as in any of Examples 14-24, wherein the second oxygen output gas is pressurized at a higher pressure than the first oxygen output gas.

Example 26 is a system as in any of Examples 14-25, wherein the second oxygen output gas comprises a higher oxygen purity concentration than the first oxygen output gas.

Example 27 is a system as in any of Examples 14-26, wherein the first oxygen output gas is stored in a low-pressure storage vessel, wherein the low-pressure storage vessel has a maximum pressure 1000 psig or less.

Example 28 is a system as in any of Examples 14-27, wherein the second oxygen output gas is stored in a high-pressure storage vessel, and wherein the high-pressure storage vessel has a maximum pressure of about 3300 psig or less.

Example 29 is a system as in any of Examples 14-28, wherein the high-pressure storage vessel has a maximum pressure of about 10,000 psig or less.

Example 30 is a system as in any of Examples 14-29, further comprising a first heater configured to heat the first electrochemical stack.

Example 31 is a system as in any of Examples 14-30, further comprising a second heater configured to heat the second electrochemical stack.

Example 32 is a system as in any of Examples 14-31, further comprising a direct current (DC) power source configured to supply a voltage to one or more of the first electrochemical stack or the second electrochemical stack.

Example 33 is a system as in any of Examples 14-32, further comprising non-flammable and porous insulation disposed around one or more of the first electrochemical stack or the second electrochemical stack.

Example 34 is a system as in any of Examples 14-33, wherein each of the first electrochemical stack and the second electrochemical stack is constructed of a ceramic material.

Example 35 is a system as in any of Examples 14-34, wherein each of the first electrochemical stack and the second electrochemical stack comprises a plurality of wafers.

Example 36 is a system as in any of Examples 14-35, wherein the first electrochemical stack comprises an anode layer disposed within an interior region of each of the plurality of wafers.

Example 37 is a system as in any of Examples 14-36, wherein the first electrochemical stack comprises a cathode layer disposed within an exterior region of each of the plurality of wafers.

Example 38 is a system as in any of Examples 14-37, wherein the second electrochemical stack comprises a cathode layer disposed within an interior region of each of the plurality of wafers.

Example 39 is a system as in any of Examples 14-38, wherein the second electrochemical stack comprises an anode layer disposed within an exterior region of each of the plurality of wafers.

Example 40 is a system. The system includes a first stage oxygen concentrator that receives an input gas and outputs a first oxygen output gas; a second stage oxygen concentrator comprising a second electrochemical stack, wherein the second stage oxygen concentrator receives the first oxygen output gas and outputs a second oxygen output gas; wherein the first oxygen output gas is stored at a first storage pressure up to a first maximum pressure; wherein the second oxygen output gas is stored at a second storage pressure up to a second maximum pressure; and wherein the second maximum pressure is greater than the first maximum pressure.

Example 41 is a system as in Example 40, wherein the first stage oxygen concentrator comprises a first electrochemical stack.

Example 42 is a system as in Example 40-41, wherein the first stage oxygen concentrator outputs the first oxygen output gas and further outputs a first oxygen-reduced gas; wherein the second stage oxygen concentrator outputs the second oxygen output gas and further outputs a second oxygen-reduced gas; and wherein the second oxygen output gas comprises a higher oxygen purity concentration than the first oxygen output gas.

Example 43 is a system as in Example 40-42, further comprising: a first stage inlet port configured to receive the input gas; a first gaseous conduit in gaseous communication with the first stage inlet port; an insulation disposed around the first gaseous conduit; and a heater configured to heat the input gas as it passes through the first gaseous conduit to generate heated input gas.

Example 44 is a system as in Example 40-43, wherein the first stage oxygen concentrator comprises a first electrochemical stack that comprises a first plurality of electrochemical cells arranged in series, and wherein the system further comprises: a first stage oxygen outlet pipeline attached to each of the first plurality of electrochemical cells and configured to receive the first oxygen output gas; and a first gas storage vessel in gaseous communication with the first stage oxygen outlet pipeline; wherein the first gas storage vessel is configured to store the first oxygen output gas at the first storage pressure up to the first maximum pressure.

Example 45 is a system as in Example 40-44, wherein the second electrochemical stack comprises a second plurality of electrochemical cells arranged in series, and wherein the system further comprises: a second stage inlet pipeline in gaseous communication with the first gas storage vessel, wherein the first oxygen output gas is fed to the second plurality of electrochemical cells by way of the second stage inlet pipeline; and a heating element disposed around the second electrochemical stack.

Example 46 is a system as in Example 40-45, further comprising: a second stage outlet pipeline configured to receive the second oxygen output gas that is concentrated by the second plurality of electrochemical cells; and a second storage vessel in gaseous communication with the second stage outlet pipeline, wherein the second storage vessel is configured to store the second oxygen output gas at the second storage pressure up to the second maximum pressure.

Example 47 is a system as in Example 40-46, wherein the first oxygen output gas is fed to the second electrochemical stack at the first storage pressure up to the first maximum pressure; and wherein the second oxygen output gas is output by the second electrochemical stack and pressurized in a chamber surrounding the second electrochemical stack prior to being stored in a storage vessel at the second storage pressure up to the second maximum pressure.

Example 48 is a system as in Example 40-47, wherein each of the first electrochemical stack and the second electrochemical stack comprises: an anode comprising a porous material that accepts oxygen molecules; a cathode comprising a porous material configured to receive a gas comprising oxygen, wherein the gas comprising oxygen is one of the input gas or the first oxygen output gas; and an electrolyte comprising a nonporous material configured to receive oxygen ions.

Example 49 is a system as in Example 40-48, wherein each of the first electrochemical stack and the second electrochemical stack further comprises: an anode secondary layer comprising a porous material that accepts oxygen molecules; and a cathode secondary layer comprising a porous material configured to receive a gas comprising oxygen, wherein the gas comprising oxygen is one of the input gas or the first oxygen output gas.

Example 50 is a system as in Example 40-49, wherein one of the first electrochemical stack or the second electrochemical stack comprises an anode cap; and wherein one of the first electrochemical stack or the second electrochemical stack comprises a cathode cap.

Example 51 is a system as in Example 40-50, wherein the input gas is ambient air.

Example 52 is a system as in Example 40-51, further comprising a low-pressure storage vessel comprising a maximum pressure from about 5 psig to about 200 psig, and wherein the first oxygen output gas is stored in the low-pressure storage vessel.

Example 53 is a system as in Example 40-52, further comprising a high-pressure storage vessel comprising a maximum pressure from about 200 psig to about 3,500 psig, and wherein the second oxygen output gas is stored in the high-pressure storage vessel.

Example 54 is a system as in Example 40-53, further comprising a high-pressure storage vessel comprising a maximum pressure from about 3,000 psig to about 10,000 psig, and wherein the second oxygen output gas is stored in the high-pressure storage vessel.

Example 55 is a system as in Example 40-54, further comprising non-flammable and porous insulation disposed around one or more of the first electrochemical stack or the second electrochemical stack.

Example 56 is a system as in Example 40-55, wherein the first electrochemical stack comprises a first plurality of wafers; wherein the second electrochemical stack comprises a second plurality of wafers; and wherein each of the first plurality of wafers and the second plurality of wafers comprises a ceramic material.

Example 57 is a system as in Example 40-56, wherein at least a portion of the first plurality of wafers comprises an anode layer disposed within a first interior region of each of the first plurality of wafers; wherein at least a portion of the first plurality of wafers comprises a cathode layer located at a first edge region of each of the first plurality of wafers; wherein at least a portion of the second plurality of wafers comprises a cathode layer disposed within a second interior region of each of the second plurality of wafers; and wherein at least a portion of the second plurality of wafers comprises an anode layer disposed within a second edge region of each of the second plurality of wafers.

Example 58 is a system as in Example 40-57, wherein at least a portion of the first plurality of wafers comprises a cathode layer disposed within a first interior region of each of the first plurality of wafers; wherein at least a portion of the first plurality of wafers comprises an anode layer located at a first edge region of each of the first plurality of wafers; wherein at least a portion of the second plurality of wafers comprises an anode layer disposed within a second interior region of each of the second plurality of wafers; and wherein at least a portion of the second plurality of wafers comprises a cathode layer disposed within a second edge region of each of the second plurality of wafers.

Example 59 is a system as in Example 40-58, receiving an input gas comprising oxygen; providing the input gas to a first stage oxygen concentrator; receiving from the first stage oxygen concentrator a first oxygen output gas and a first oxygen-reduced gas; storing the first oxygen output gas in a first storage vessel at a first storage pressure up to a first maximum pressure; providing the first oxygen output gas to a second stage oxygen concentrator comprising a second stage electrochemical stack; receiving from the second stage electrochemical stack a second oxygen output gas and a second oxygen-reduced gas; and storing the second oxygen output gas in a second storage vessel at a second storage pressure up to a second maximum pressure; wherein the second maximum pressure is greater than the first maximum pressure; and wherein the second oxygen output gas comprises a higher oxygen purity concentration than the first oxygen output gas.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A system comprising:
a first stage oxygen concentrator that receives an input gas and outputs a first oxygen output gas;
a second stage oxygen concentrator comprising a second electrochemical stack, wherein the second stage oxygen concentrator receives the first oxygen output gas and outputs a second oxygen output gas;
wherein the first oxygen output gas is stored at a first storage pressure up to a first maximum pressure;
wherein the second oxygen output gas is stored at a second storage pressure up to a second maximum pressure; and
wherein the second maximum pressure is greater than the first maximum pressure.

2. The system of claim 1, wherein the first stage oxygen concentrator comprises a first electrochemical stack.

3. The system of claim 1, wherein the first stage oxygen concentrator outputs the first oxygen output gas and further outputs a first oxygen-reduced gas;
wherein the second stage oxygen concentrator outputs the second oxygen output gas and further outputs a second oxygen-reduced gas; and
wherein the second oxygen output gas comprises a higher oxygen purity concentration than the first oxygen output gas.

4. The system of claim 1, further comprising:
a first stage inlet port configured to receive the input gas;
a first gaseous conduit in gaseous communication with the first stage inlet port;
an insulation disposed around the first gaseous conduit; and
a heater configured to heat the input gas as it passes through the first gaseous conduit to generate heated input gas.

5. The system of claim 1, wherein the first stage oxygen concentrator comprises a first electrochemical stack that comprises a first plurality of electrochemical cells arranged in series, and wherein the system further comprises:
a first stage oxygen outlet pipeline attached to each of the first plurality of electrochemical cells and configured to receive the first oxygen output gas; and
a first gas storage vessel in gaseous communication with the first stage oxygen outlet pipeline;
wherein the first gas storage vessel is configured to store the first oxygen output gas at the first storage pressure up to the first maximum pressure.

6. The system of claim 5, wherein the second electrochemical stack comprises a second plurality of electrochemical cells arranged in series, and wherein the system further comprises:
a second stage inlet pipeline in gaseous communication with the first gas storage vessel, wherein the first oxygen output gas is fed to the second plurality of electrochemical cells by way of the second stage inlet pipeline; and
a heating element disposed around the second electrochemical stack.

7. The system of claim 6, further comprising:
a second stage outlet pipeline configured to receive the second oxygen output gas that is concentrated by the second plurality of electrochemical cells; and
a second storage vessel in gaseous communication with the second stage outlet pipeline, wherein the second storage vessel is configured to store the second oxygen output gas at the second storage pressure up to the second maximum pressure.

8. The system of claim 1, wherein the first oxygen output gas is fed to the second electrochemical stack at the first storage pressure up to the first maximum pressure; and
wherein the second oxygen output gas is output by the second electrochemical stack and pressurized in a chamber surrounding the second electrochemical stack prior to being stored in a storage vessel at the second storage pressure up to the second maximum pressure.

9. The system of claim 2, wherein each of the first electrochemical stack and the second electrochemical stack comprises:
an anode comprising a porous material that accepts oxygen molecules;
a cathode comprising a porous material configured to receive a gas comprising oxygen, wherein the gas comprising oxygen is one of the input gas or the first oxygen output gas; and
an electrolyte comprising a nonporous material configured to receive oxygen ions.

10. The system of claim 2, wherein each of the first electrochemical stack and the second electrochemical stack further comprises:
an anode secondary layer comprising a porous material that accepts oxygen molecules; and
a cathode secondary layer comprising a porous material configured to receive a gas comprising oxygen, wherein the gas comprising oxygen is one of the input gas or the first oxygen output gas.

11. The system of claim 2, wherein one of the first electrochemical stack or the second electrochemical stack comprises an anode cap; and
wherein one of the first electrochemical stack or the second electrochemical stack comprises a cathode cap.

12. The system of claim 1, wherein the input gas is ambient air.

13. The system of claim 1, further comprising a low-pressure storage vessel comprising a maximum pressure from about 5 psig to about 200 psig, and wherein the first oxygen output gas is stored in the low-pressure storage vessel.

14. The system of claim 1, further comprising a high-pressure storage vessel comprising a maximum pressure from about 200 psig to about 3,500 psig, and wherein the second oxygen output gas is stored in the high-pressure storage vessel.

15. The system of claim 1, further comprising a high-pressure storage vessel comprising a maximum pressure from about 3,000 psig to about 10,000 psig, and wherein the second oxygen output gas is stored in the high-pressure storage vessel.

16. The system of claim 2, further comprising non-flammable and porous insulation disposed around one or more of the first electrochemical stack or the second electrochemical stack.

17. The system of claim 2, wherein the first electrochemical stack comprises a first plurality of wafers;
wherein the second electrochemical stack comprises a second plurality of wafers; and
wherein each of the first plurality of wafers and the second plurality of wafers comprises a ceramic material.

18. The system of claim 17, wherein at least a portion of the first plurality of wafers comprises an anode layer disposed within a first interior region of each of the first plurality of wafers;
wherein at least a portion of the first plurality of wafers comprises a cathode layer located at a first edge region of each of the first plurality of wafers;
wherein at least a portion of the second plurality of wafers comprises a cathode layer disposed within a second interior region of each of the second plurality of wafers; and
wherein at least a portion of the second plurality of wafers comprises an anode layer disposed within a second edge region of each of the second plurality of wafers.

19. The system of claim 17, wherein at least a portion of the first plurality of wafers comprises a cathode layer disposed within a first interior region of each of the first plurality of wafers;
wherein at least a portion of the first plurality of wafers comprises an anode layer located at a first edge region of each of the first plurality of wafers;
wherein at least a portion of the second plurality of wafers comprises an anode layer disposed within a second interior region of each of the second plurality of wafers; and
wherein at least a portion of the second plurality of wafers comprises a cathode layer disposed within a second edge region of each of the second plurality of wafers.

20. A method comprising:
receiving an input gas comprising oxygen;
providing the input gas to a first stage oxygen concentrator;
receiving from the first stage oxygen concentrator a first oxygen output gas and a first oxygen-reduced gas;
storing the first oxygen output gas in a first storage vessel at a first storage pressure up to a first maximum pressure;
providing the first oxygen output gas to a second stage oxygen concentrator comprising a second stage electrochemical stack;
receiving from the second stage electrochemical stack a second oxygen output gas and a second oxygen-reduced gas; and
storing the second oxygen output gas in a second storage vessel at a second storage pressure up to a second maximum pressure;
wherein the second maximum pressure is greater than the first maximum pressure; and
wherein the second oxygen output gas comprises a higher oxygen purity concentration than the first oxygen output gas.
